(19) United States
(12) Patent Application Publication
(10) Pub. No.: US 2005/0172533 A1
(43) Pub. Date: Aug. 11, 2005

(54) Lure with replaceable battery

(76) Inventor: Li Fu, Gymea Bay (AU)

Correspondence Address: MICHAEL MOLINS;MOLINS & CO., SUITE S, LEVEL 6, 139 MACQUARIE ST, SYDNEY NSW, 2000, AU

(21) Appl. No.: 10/913,324

(22) Filed: Aug. 9, 2004

(30) Foreign Application Priority Data
Feb. 5, 2004 (AU) 2004200488

(51) Int. Cl. A01K 85/01

(52) U.S. Cl. 43/17.6

(57) ABSTRACT

Provided is an artificial fishing lure with a hollow body. The body has within it, a light source and a bay for receiving a replaceable battery cartridge. The battery cartridge comprises a battery holder that serves to both retain the battery and maintain an effective seal with the lure body. When the cartridge is removed, the battery comes with it making replacement of the battery feasible.

### FIELD OF THE INVENTION

The invention pertains to artificial fishing lures and more particularly to light emitting fishing lures with a replaceable battery.

### BACKGROUND OF THE INVENTION

Illuminated fishing lures are well known. Generally an illuminated lure comprises a hollow body within which is located an electrical light source, circuitry and a battery. In order to protect the light source, circuitry and the battery from the surrounding water, the body or case of the lure is sealed. This serves to protect the light, the circuitry and the battery but makes replacement of the battery unfeasible. In this situation, when the battery expires, the lure is either discarded or used without the light source.

### OBJECTS AND SUMMARY OF THE INVENTION

It is an object of the present invention to provide an artificial fishing lure with a replaceable battery.

Accordingly, there is provided an artificial fishing lure with a hollow body. The body has within it, a light source, and a bay for receiving a replaceable battery cartridge. The bay further comprises mechanical and electrical features that facilitate receiving the battery cartridge. The battery cartridge comprises a polymeric battery holder that serves to both retain the battery and maintain an effective seal with the lure body. When the cartridge is removed, the battery comes with it making replacement of the battery feasible.

### BRIEF DESCRIPTION OF THE DRAWING FIGURES

FIG. 1 is an exploded perspective view of an artificial fishing lure incorporating the teachings of the present invention.

FIG. 2 is an exploded perspective of the device depicted in FIG. 2 with the battery cartridge inserted in the body; and

FIG. 3 is a perspective view of a lure of the type depicted in FIGS. 1 and 2.

### BEST MODE AND OTHER EMBODIMENTS OF THE INVENTION

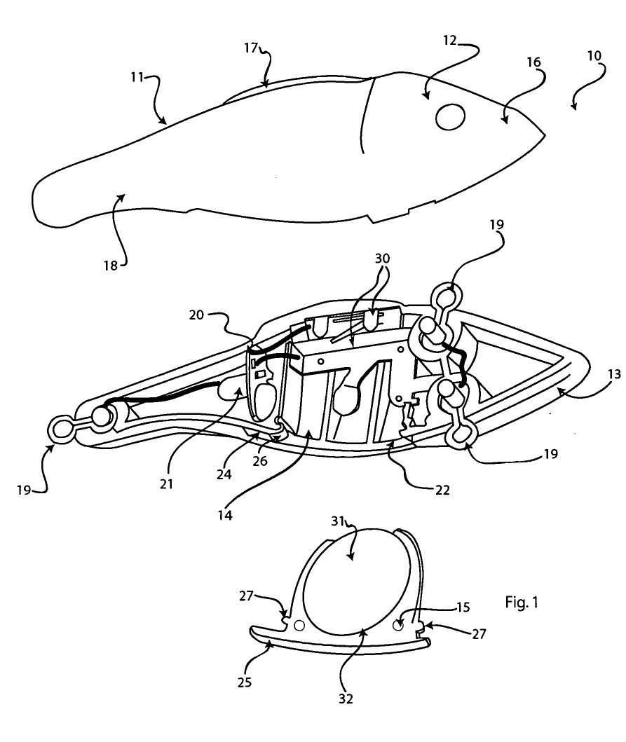

As shown in FIG. 1, an artificial fishing lure 10 comprises a rigid polymeric body 11 which may be conveniently assembled from 2 body halves 12, 13. In preferred embodiments, the halves 12, 13 are ultrasonically welded together or otherwise permanently joined to provide a shell having a single entrance opening or bay 14. As will be further explained, that bay 14 is adapted to receive a replaceable battery cartridge 15, for example a thin “hearing aid” type battery. The body 11 in this instance is preferably translucent and in the shape of a small fish as evidenced by the head section 16 raised fin 17 and tapered tail portion 18. The artificial lure 10 also incorporates metal eyelets 19. The eyelets 19 are in part external to the body 11 but electrically wired to the primary circuit board 20 that carries or controls an illuminator or light source such as an LED 21. In some embodiments of the invention, at least one of the forward eyelets as well as the rear or tail mounted eyelet must be in the water to complete the circuit that activates the illuminator 21. Another device such as a vibrator or sonic emitter may replace or augment the illuminator and be powered the same way as described here.

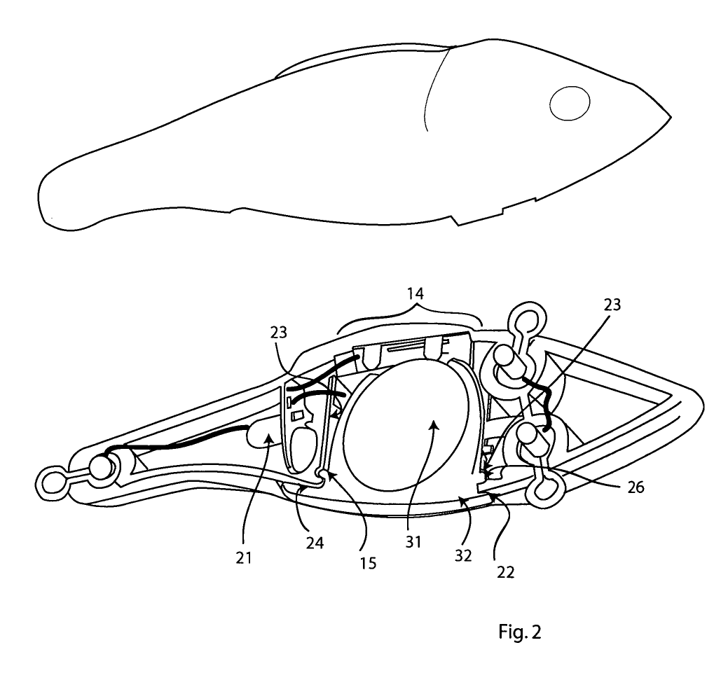

As better shown in FIG. 2, the central portion of the body 10 incorporates a bay 14. The bay is characterised by a mouth or opening 22 and in this example, sidewall portions 23 which are adapted to retain the battery cartridge 15. The mouth 22 of the bay 14 may also include a recessed portion 24 for concealing a finger tab 25 that is integral with the cartridge 15. The mouth 22 may also incorporate grooves 26 which are adapted to engage and retain ridges or beads 27 which are integral with the cartridge 15. It will be appreciated that the arrangement of grooves and beads may be reversed such that the grooves are provided on the cartridge with the beads provided in the bay. Other conventional sealing features may be used to improve the seal between the cartridge 15 and the hollow body 10. The internal portion of the bay also includes metal components 30 which are adapted to make electrical contact with the battery 31.

In preferred embodiments, the battery 31 is a ‘hearing aid’ type battery and is removably retained by the cartridge 15. The cartridge includes a recess for receiving the battery 31 as well as features 26 for improving the seal between the cartridge and the body. The cartridge also includes and exterior portion 32 which conforms to the external shape of the body and is generally flush with it when the cartridge is fully inserted. The cartridge may also include an elongated finger tab 24 to make removal of the cartridge easier.

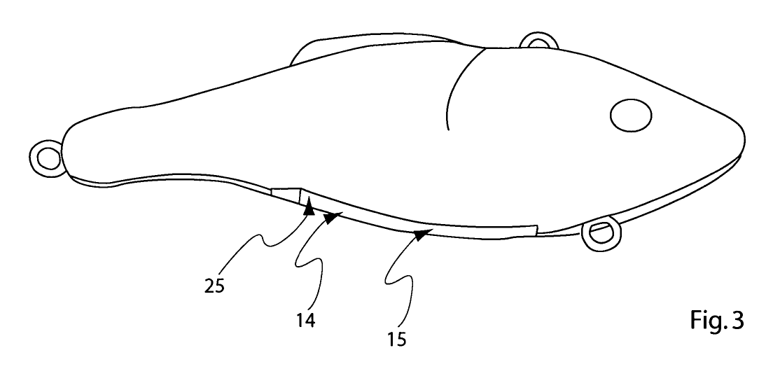

The external features of the lure are depicted in FIG. 3. As shown in that image, the battery cartridge 15 does not interfere with the hydrodynamic qualities of the lure and blends smoothly with the external shape of the body.

While the present invention has been shown with respect to particular details of construction, these should be understood as having been provided by way of example and not as limitations to the scope or spirit of the invention.

1. A fishing lure comprising:
a hollow body within which is located an electrical illuminator, the body having a bay;
the bay having electrical contacts; and
a replaceable cartridge that is adapted to seat within the bay and seal it.

2. The lure of claim 1, wherein:
the cartridge is adapted to retain a battery and bring the battery into electrical junction with the contacts when the cartridge is inserted into the bay.

3. The lure of claim 1, wherein:
the cartridge seals the bay from the entry of water when the cartridge is seated in the bay.

4. The lure of claim 2, wherein:
the bay and cartridge further comprise mechanical sealing features that improve the seal.

5. The lure of claim 4, wherein:
the features are one or more cooperating grooves and ridges.

6. The lure of claim 1, wherein:
the cartridge further comprises a finger tab for facilitating removal.

7. The lure of claim 6, wherein:
the body further comprises a recess for receiving the finger tab.

8. The lure of claim 1, wherein:
the cartridge is adapted to retain a hearing aid style battery.

9. The lure of claim 1, wherein:
the body is translucent.

10. The lure of claim 9, wherein:
the body is in the shape of a fish.

11. The lure of claim 1, wherein:
the body incorporates external contacts which when immersed in water complete a circuit that activates the illuminator.

12. The lure of claim 1, wherein:
the body is formed from two halves that are joined together.

13. The lure of claim 1, wherein:
the cartridge is generally flush with an exterior of the body when the cartridge is installed in the bay.
